(19) United States
(12) Patent Application Publication
(10) Pub. No.: US 2014/0081860 A1
(43) Pub. Date: Mar. 20, 2014

(54) NEAR FIELD CONTACTLESS SYSTEM AND METHOD FOR ONLINE TRANSACTIONS

(71) Applicants: Farid Adrangi, Lake Oswego, OR (US); Victor B. Lortz, Beaverton, OR (US)

(72) Inventors: Farid Adrangi, Lake Oswego, OR (US); Victor B. Lortz, Beaverton, OR (US)

(21) Appl. No.: 13/621,474

(22) Filed: Sep. 17, 2012

(51) Int. Cl. G06Q 20/32

(52) U.S. Cl. CPC G06Q 20/3278; G06Q 20/4012
USPC 705/44; 705/39

(57) ABSTRACT

Systems, methods, and apparatuses are directed to conducting online transactions by virtue of a near field communication (NFC) reading mechanism configured to contactlessly read NFC-compliant provisioning information including a monetary value. Moreover, logic is configured to initiate establishment of a communication link, automatically send a request message to confirm the read provisioning information via the communication link, store at least a portion of the provisioning information in a secure memory unit, and based on the confirmation of the provisioning information, automatically present on a display unit, the monetary value, selectable transaction options, and an online information resource link to accommodate execution of a selected transaction option.

### TECHNICAL FIELD

This disclosure relates generally to the field of data processing/communications, and in particular, to near field communications directed to online transactions.

### BACKGROUND ART

Given consumer convenience, card-based currency, such as, for example, prepaid cards, gift cards, reward cards, loyalty cards, redeeming coupons, discount vouchers, etc., is fast becoming a preferred medium for consummating transactions of goods and services.

Generally, such card-based currency includes a unique identifier printed in small font on the card encoded in a barcode and/or magnetic strip. In addition, such cards may also contain a scratch-off or peel-away portion concealing a PIN code to be inputted by the consumer.

In using such a card for online transactions, users must first find, via a computer, the web page of a retailer's online store, launch the webpage, and then navigate through retailer's website to find the gift card area. To check the balance/value of the card or use the gift card online, the user must manually enter into the retailer web page, the long string of digits of the identifier printed on the gift card as well as the scratch-off/peel-away concealed PIN code.

These user steps are susceptible to errors if the user enters the online retailer Uniform Resource Locator (URL) incorrectly in addition to being susceptible to a variety phishing attacks if malware, such as, a key logger, is running in the background of the user computer.

### BRIEF DESCRIPTION OF THE DRAWINGS

FIG. 1 depicts a high-level functional block diagram of an NFC contactless system conducting online transactions, in accordance with various aspects of the present disclosure.

FIG. 2 depicts a high-level functional block diagram of an NFC device, in accordance with various aspects of the present disclosure.

FIG. 3 depicts a high-level functional block diagram of an NFC-enabled reading device, in accordance with various aspects of the present disclosure.

FIG. 4 depicts a high-level flow diagram of a process for conducting online transactions based on an NFC contactless system, in accordance with various aspects of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is proposed is an electronic device and system for conducting online transactions that includes a display unit, a secure memory unit, a near field communication (NFC) reading mechanism configured to contactlessly read NFC-compliant provisioning information including a monetary value and logic configured to: (a) initiate establishment of a communication link, (b) automatically send a request message to confirm the read provisioning information via the communication link, (c) store at least a portion of the provisioning information in the secure memory unit, and (d) based on the confirmation of the provisioning information, automatically present on the display unit, the monetary value, selectable transaction options, and an online information resource link to accommodate execution of a selected transaction option.

In another embodiment, a method for conducting online transactions is presented that includes contactlessly reading near field communication (NFC)-compliant provisioning information that includes a monetary value, initiating establishment of a communication link, automatically sending a request message to confirm the read provisioning information via the communication link, storing at least a portion of the provisioning information in a secure memory unit, automatically presenting, on a display unit, the monetary value, selectable transaction options, and an online information resource interface to accommodate execution of a selected transaction option, in response to the confirmation of the provisioning information.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

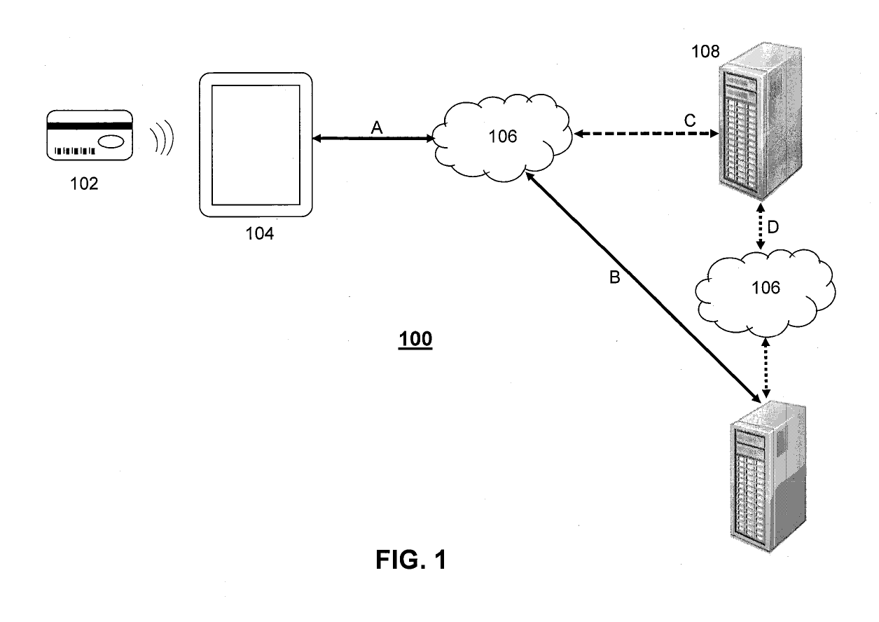

FIG. 1 depicts a high-level functional block diagram of a near field communication-based (NFC) contactless system 100 for conducting online transactions, in accordance with various aspects of the present disclosure. NFC is a short-range wireless connectivity technology that provides digital communication between NFC-enabled devices by touching them together or placing them within a close proximity to each other (e.g., approximately two inches). As specified by the ISO/IEC 18092 and related standards, a communication link is established between two NFC-capable devices when the distance between them is approximately 0-4 cm, although distances of up to about 20 cm is contemplated. NFC devices typically operate at a frequency of 13.56 MHz and may transfer data at rates up to 424 Kbs, although data transfer rates of up to 2 Mbps is contemplated.

As illustrated, system 100 includes NFC device 102, NFC reading-enabled electronic device 104 having bi-directional NFC communication capabilities, and at least one retail transaction source or provider 110. As discussed in greater detail below, system 100 is configured to provide a secure online transaction based on information provided by a contactless NFC device 102.

In the embodiment depicted in FIG. 1, NFC device 102 is in the form of a card. It will be appreciated that device 102 may equally take the form of a wristband, sticker, banner, key fob, or other suitable media, consistent with the disclosed embodiments. It will also be appreciated that NFC device 102 may operate as a prepaid card, gift card, reward card, loyalty card, coupon, discount voucher, or other redeemable certificate having an associated monetary value.

Moreover, NFC device (card) 102 is provisioned by a retail provider with a separate NFC-concealed card ID/number that is different from the NFC card number printed on NFC card 102, for security reasons. Each NFC card 102 also includes a scratch-off/peel-away concealed PIN code, which is to be used during online transactions. It will also be appreciated that a secret functionally corresponding to the concealed PIN code may be established and communicated to the user through alternative means, such as being sent in an SMS, email, or printed on a receipt when the NFC card is first activated at purchase time. The main requirement is that this additional secret “PIN” cannot be read via NFC. Furthermore, NFC cards 102 initially have zero balance until provisioned at purchase time. When the NFC card 102 is purchased, the value is credited to the account associated with the purchased NFC card 102 by storing the value in the retail provider server 110 facilities.

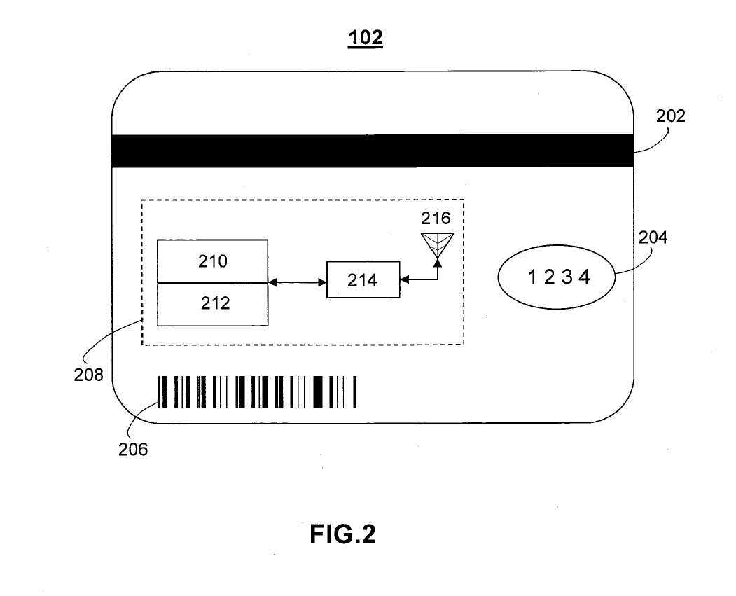

To this end, FIG. 2 depicts NFC device (card) 102 in greater detail, in accordance with in accordance with various aspects of the present disclosure. In particular, NFC card 102 includes NFC tag 208, scratch-off/peel-away concealed PIN code 204 and may additionally include magnetic strip 202 and/or barcode 206. NFC tag 208 comprises a microchip including a processing device 210, a storage device 212, a transceiver device 214, and an antenna device 216. The NFC tag 208 is typically configured as a passive device (i.e., lacking its own power source) and is energized by being inductively coupled, via antenna device 216, to the magnetic field generated by the radio frequency (RF) signal transmitted by a proximally situated NFC reading device (e.g., NFC reading-enabled electronic device 104). As noted above, the RF transmitted signal may operate at 13.56 MHz in accordance with ISO/IEC 18092 standards.

The NFC processing device 210 and storage device 212 of NFC card 102 are coupled to NFC transceiver device 214. Storage device 212 may be configured as volatile or non-volatile memory and may store retailer-based transaction provisioning information, such as, for example, retailer data, URL access data, value data, NFC-concealed card ID data, security data etc. The retailer-based transaction provisioning information may be formatted in accordance with NFC standards to ensure effective recognition and interactions with retail provider server(s) 110.

NFC transceiver device 214 is configured to transmit the provisioning information from storage device 212, under the command of processing device 210, in response to establishing a communication link with a compatible NFC reading device (e.g., NFC reading-enabled electronic device 104). By way of illustration, NFC standards specify storage capacities of up to 4 MBytes and as noted above, data transfer data rates up to 424 kbit/s. However, it will be appreciated that the embodiments disclosed herein are not limited to the operating parameters noted above, as the disclosed configuration may operate at RF frequencies other than 13.56 MHz, provide for storage capacities lesser than or greater than 4 Mbytes, and communicate at data rates less than or greater than 424 kbit/s.

Returning back to FIG. 1, upon bringing NFC card 102 within proximity (i.e., tapping distance) of NFC reading-enabled electronic device 104, device 104 is configured to energize NFC card 102, establish a communication link with NFC card 102, and read the transaction provisioning information from NFC card 102. NFC reading-enabled electronic device 104 may represent any of a number of electronic and/or computing devices, both wireless and wired. As such, NFC reading-enabled electronic device 104 may comprise desktops, laptops, mobile devices, smart phones, gaming devices, tablet computers, etc.

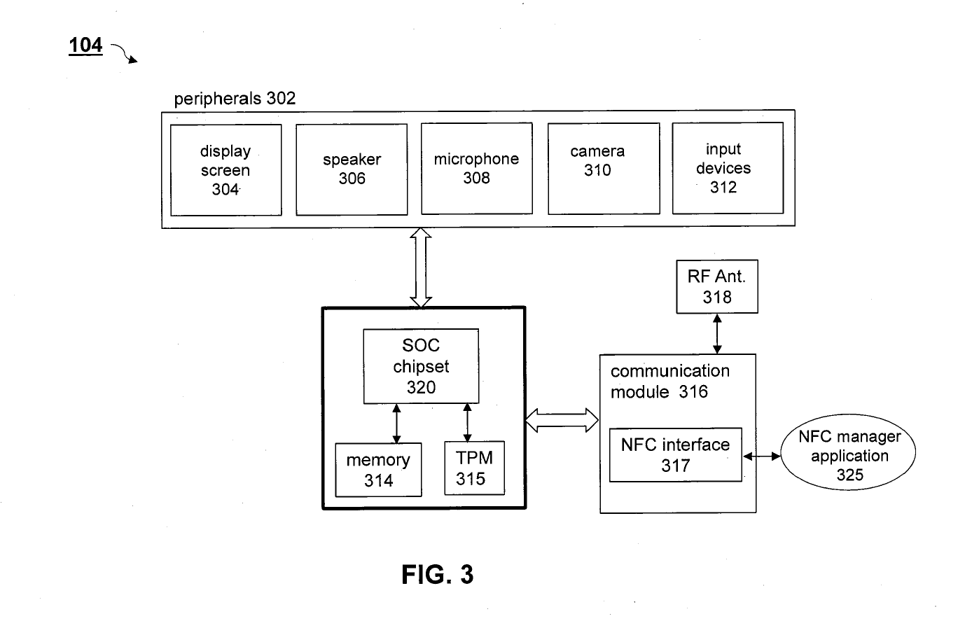

As depicted in greater detail, FIG. 3 illustrates a high-level functional block diagram of NFC reading-enabled electronic device 104, in accordance with various aspects of the present disclosure. In the illustrative example, reading-enabled electronic device 104 includes a variety of peripherals, such as, for example, display screen 304, speaker 306, microphone 308, camera 310, input devices 312, as well as memory 314, a Trusted Platform Module (TPM) chipset 315, communication module 316, antenna 318, and a system-on-chip (SoC) chipset 320. NFC reading-enabled electronic device 104 may also include a bus infrastructure and/or other interconnection means to connect and communicate information between various components of device 104.

In some embodiments, SoC 320 may be part of a core processing or computing unit of NFC reading-enabled electronic device 104, and is configured to receive and process input data and instructions, provide output and/or control other components of device 104 in accordance with embodiments of the present disclosure. SoC 320 may include a microprocessor, a memory controller, a memory and other components. The microprocessor may further include a cache memory (e.g., SRAM), which along with the memory of SoC 320 may be part of a memory hierarchy to store instructions and data. The microprocessor may also include one or more logic modules such as a field programmable gate array (FPGA) or other logic array. Communication between the SoC 320's microprocessor and memory may be facilitated by the memory controller (or chipset), which may also facilitate communication with peripheral components 302.

Memory 314 of NFC reading-enabled electronic device 104 may be a dynamic storage device coupled to the bus infrastructure and configured to store information, instructions, and programs, such as NFC device transaction manager application 325, to be executed by processors of SoC 320 and/or other processors (or controllers) associated with device 104. Some of all of memory 314 may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. Device 104 may also include read only memory (ROM) and/or other static storage devices coupled to the bus infrastructure and configured to store static information and instructions for processors of SoC 320 and/or other processors (or controllers) associated with device 104.

Trusted Platform Module (TPM) chipset 315 comprises a security device that stores computer-generated keys for encryption. It is a hardware-based solution intended to prevent the hacking of key entries, passwords, encryption keys, and other sensitive data. TPM chipset 315 may comprise core root of trust measurement (CRTM) module, encryptor module, decryptor module, key generator, a random number generator (RNG), hash engine, and platform configuration registers (PCRs). In one embodiment, the TPM chipset 315 is coupled to associated processors, via the bus infrastructure, or may alternatively be integrated into SoC 320.

Communication module 316 includes NFC interface 317 which comprises transceiver, transponder, modulation/demodulation, and memory circuitry, configured to wirelessly communicate and transmit/receive information, via the generated RF signal, upon establishing an NFC communication link with NFC card 102. Moreover, as discussed in further detail below, upon establishing the NFC communication link, NFC interface 317 initiates the launching of NFC device transaction manager logic/application 325 which facilitates the secure online transaction based on information provided by contactless NFC card 102.

Returning to FIG. 1, upon establishing the NFC communication link between NFC card 102 and NFC reading-enabled electronic device 104, NFC reading-enabled electronic device 104 is configured to read the retailer-based transaction provisioning information stored by NFC card 102. As noted above, such provisioning information may include, for example, formatted retailer data, retailer URL access data, value data, NFC-concealed card ID data, account data, security data, etc.

Upon reading the provisioning information stored by NFC card 102, NFC interface 317 of NFC reading-enabled electronic device 104 notifies NFC device transaction manager application 325 to initiate the launching of the application 325. NFC device transaction manager application 325 is configured to examine the formatted provisioning information and determine the nature of the transaction and identity of the retail provider. In one embodiment, for example, NFC device transaction manager application 325 examines URL data (or a portion thereof), card ID number data and/or account data contained in the read provisioning information to determine which server (i.e., secure retail transaction provider 110) to contact that is affiliated with NFC card 102 or the associated account.

The NFC device transaction manager application 325 may store the read provisioning information in memory and in some embodiments may also store provisioning information from previously-seen gift cards and additional information associated with the owner of NFC reading-enabled electronic device 104, such as user name and mailing address, that may be relevant to consummating online transactions. In some embodiments, NFC device transaction manager application 325 or other software applications on the NFC reading-enabled electronic device 104 may be pre-configured with specific base URLs of affiliated merchants so that it can appropriately respond to relevant cards while ignoring other NFC cards or devices that store URLs for purposes other than a specific online transaction (i.e., gift/loyalty card redemption).

In some embodiments, confidential or sensitive information, including some or all aspects of the combination of provisioning information and user information, may be protected by NFC processing component, such as, for example, Trusted Platform Module (TPM) chipset 315, that reads the provisioning information and stores it along with additional security information, such as a PIN code, in a protected memory region to protect the NFC card 102 ID number from exposure to any malware that might be running on NFC reading-enabled electronic device 104.

As noted above, once the NFC device transaction manager application 325 examines the read provisioning information of NFC card 102 and determines which secure retail transaction provider server 110 is associated with the information, it triggers NFC reading-enabled electronic device 104 to automatically (i.e., without user intervention) contact server 110 directly via network 106 with a request for confirmation and/or information regarding NFC card 102, as indicated by route A-B in FIG. 1. The communication mechanism and network are not intended to be limiting in any way, as the communications could be based on one or more standards and protocols including, but not limited to, Ethernet, Wi-Fi, Wi-Gi, Bluetooth, GSM, CDMA, GPRS, 3G or 4G (e.g., WiMAX, LTE) cellular standards, Wireless USB, satellite communication, etc. and the network 106 may comprise the Internet other any suitable network, such as intranets, extranets, etc. In some embodiments, for example, the request may be transmitted over an established secure communication link, such as, for example, a secure tunnel (e.g., SSL) setup between NFC card 102 and retail provider server 110.

In response to the request by NFC reading-enabled electronic device 104, retailer provider server 110 provides confirmation of the account and related information, such as the value or current balance of the account associated with NFC card 102, via the networked communications. Armed with the responsive value/balance information, NFC device transaction manager application 325 enables NFC reading-enabled electronic device 104 to display the value/balance information and retail provider's online transaction link information to the user via display screen 304. In some embodiments, NFC device transaction manager application 325 may also present user-selectable options, such as, for example: (1) go to online store, (2) add to the card balance, (3) save card information for future reference.

If the “go to online store” option is selected by the user, the NFC reading-enabled electronic device 104 opens the associated link and connects to the online portal of the retail provider, based on the read URL. In response, retail provider server 110 will open an electronic information resource interface, such as a web-page, designated for online purchases and/or redemption and proceed with conducting a redeeming or purchase transaction.

In addition, as a user-selectable sub-option, the NFC reading-enabled electronic device 104 may also furnish the retailer web-page with the NFC card 102 number as well as the user name and address to expedite the checkout process. Furthermore, if the NFC reading-enabled electronic device 104 has any collected any digital coupons that might be relevant to that particular transaction, the digital coupon codes may be presented to the shopping portal at the same time.

To consummate the purchase/redemption transaction, at the online checkout process, the user will be able to select a gift/loyalty/coupon/voucher card payment option, as provided by the retailer web-page and enter the scratch-off/peel-away concealed PIN code 204 to confirm the transaction. It will be appreciated that, based on the disclosed configuration, there is no need for the user to enter the NFC card number since that information has been confirmed by retailer provider server 110 and may pre-populate and be displayed in a checkout form with asterisks hiding the NFC-concealed card ID data or any portion thereof. Furthermore, NFC device transaction manager application 325 may store and provide the concealed PIN code 204 for subsequent use in online checkout, so that the user will only need to enter it once on electronic device 104 for a particular NFC card.

With regard to the “add to the card balance” option, again, the initial step is to display the current card balance. To do this, the NFC manager application 325 reads the NFC card 102 number and URL access data and uses the URL to query the current card balance from the retail provider server 110. This balance can be shown to the user on a graphical display so that they can have almost instant access to this information. Because there may be no compelling need to require the user to prove knowledge of the secret PIN code for such a transaction, such a step may be optional and in accord with the retailer policies. If the user decides to add to the card balance, payment via some other means is made to the retail provider server 110. For example, a credit card, bank account, or another gift card can be used with the online connection to add value to the NFC card 102 account.

With regard to the “save card information for future reference” option, the NFC manager application 325 uses secure memory 314 or the TPM 315 to save information such as the NFC card number, URL access data, secret PIN code, and possibly the user's personal information such as name and address. With this information saved and protected from malware, the NFC manager application 325 can display and use this information in the future without requiring the user to physically present NFC card 102 again. Thus, if NFC card 102 is lost, stolen, or destroyed for some reason, the associated value can still be preserved and used without having to explain or provide proof of purchase to the retailer.

As noted above, the NFC-concealed card ID data stored in storage device 212 of NFC card 102 differs from the numbers printed on the card or stored in the cards magnetic strip for security reasons. It will be appreciated that once the NFC-concealed card ID/number data is stored by NFC reading-enabled electronic device 104, the user can use that stored record for subsequent online transactions or to check the card balance without having to physically touch NFC card 102 again to NFC reading-enabled electronic device 104. In some embodiments, additional options may be presented to the user, such as requests to have the balance of the NFC card 102 transferred to another card/account from the same retail provider or to a virtual card with a different gift card number. This feature allows the user to protect the NFC card 102 value in case it becomes lost or stolen.

As discussed above, based on the provisioning information, the NFC reading-enabled electronic device 104 may directly contact retail provider server 110 via network 106 with a request for confirmation and/or information, as indicated by route A-B in FIG. 1. In some embodiments, however, it may be beneficial for NFC reading-enabled electronic device 104 to first access and communicate with a trusted, intermediary, third party server 108 prior to communicating with retail provider server 110, as indicated by route A-C-D in FIG. 1.

By way of illustration, retail provider server 110 may have an arrangement with third party server 108 to provide an array of pre-specified services. The communication link between third party server 108 and retail provider server 110 will preferably be secure. As such, prior to granting access to retail provider server 110 and accepting/responding to requests from NFC reading-enabled electronic device 104, third party server 108 may perform certain functionality, such as, for example, verifying data integrity, performing virus scans, scanning for malware, comparing security hashes, verifying sources, verifying digital signatures, ensuring database integrity, billing, collections, authenticating users, verifying user contact information, etc., thereby relieving retail provider server 110 from having to perform such functionality.

In this configuration, retail provider may incorporate NFC card 102 with URL access data to third party server 108, so that third party server 108 may directly receive confirmation/information requests from NFC reading-enabled electronic device 104. The third party server 108 will then process the NFC card 102 provisioning information and then forward the processed information to retail provider server 110 for transaction completion.

Alternatively, or in addition to, the retail provider server 110 may first receive confirmation/information requests from NFC reading-enabled electronic device 104, as discussed in the previously noted embodiments, and retail provider server 110 may then forward or “bounce” such requests to third party server 108 for processing.

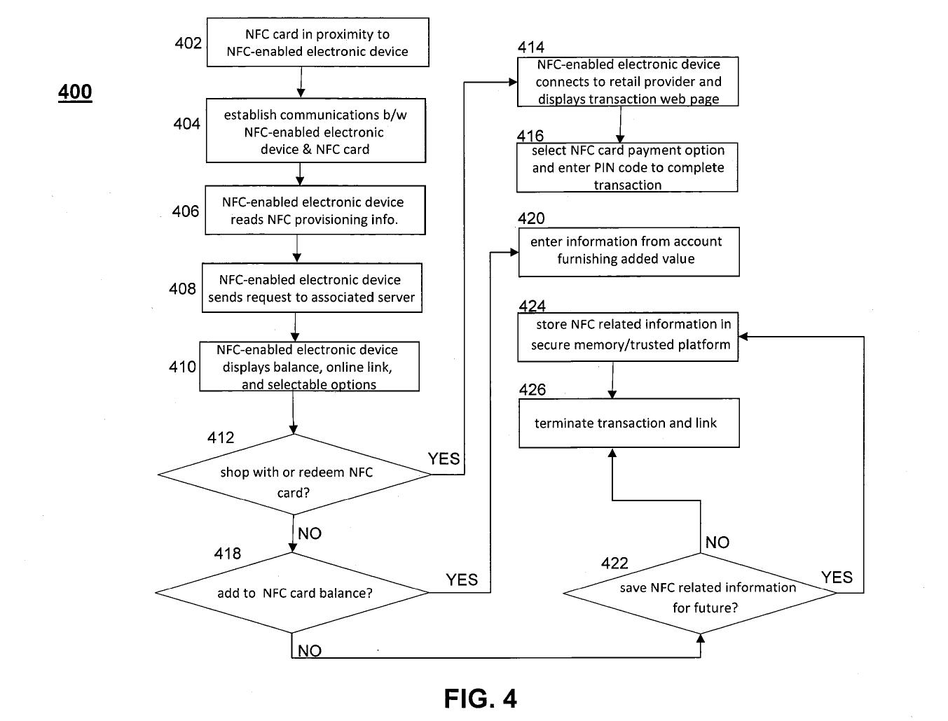

FIG. 4 depicts a high-level flow diagram of process 400 for conducting online transactions based on an NFC contactless system, in accordance with various aspects of the present disclosure. In block 402, NFC card 102 is brought within proximity of NFC reading-enabled electronic device 104, which results in device 104 energizing NFC card 102 and establishing a communication link between NFC reading-enabled electronic device 104 and NFC card 102, as indicated in block 404.

In block 406, NFC reading-enabled electronic device 104 reads, via the communication link, the transaction provisioning information stored in the memory of NFC card 102. As noted above, the provisioning information may include retailer data, URL access data, value data, NFC-concealed card ID data, security data etc. In response to the reading of the provisioning information, in block 408, the NFC device transaction manager application 325 residing in NFC reading-enabled electronic device 104, examines the provisioning information that is read, determines which retail transaction provider server 110 is associated with the information, and causes NFC reading-enabled electronic device 104 to forward a request for confirmation/information to the transaction server associated with the account of NFC 102. That is, as discussed above, the provisioning information may include data indicative of contacting/communicating directly with retailer provider server 110 (i.e., provider of the NFC card) or data indicative of contacting/communicating a trusted third party intermediary server 108.

Based on the information provided in the response to the request by the transaction server, in block 410, NFC device transaction manager application 325 triggers NFC reading-enabled electronic device 104 to display the account balance associated with NFC card 102 and displays retail provider's online transaction link information. The user may also be provided with user-selectable transaction options, such as: (1) go to online store, (2) add to the card balance, (3) save card information for future reference.

In block 412, it is determined whether the user elects to conduct a purchasing transaction (or redeem) by using NFC card 102. If so, in block 414, the NFC reading-enabled electronic device 104 opens the associated link and connects to the online portal of the retail provider, based on the read URL. In response, retail provider server 110 will open an electronic information resource interface, such as a web-page, designated for online purchases and/or redemption, which is displayed by NFC reading-enabled electronic device 104 and designated for online purchases and/or redemption and provides means for conducting a redeeming or purchase transaction. In addition, as noted above, for a user-selectable transaction options, the NFC reading-enabled electronic device 104 may also furnish the retailer web-page with the NFC card 102 number as well as the user name and address to expedite the checkout process. Furthermore, if the NFC reading-enabled electronic device 104 has any collected any digital coupons that might be relevant to that particular transaction, the digital coupon codes may be presented to the shopping portal at the same time.

In block 416, to complete the purchase/redemption transaction, during the retailer online checkout process, a gift/loyalty/coupon/voucher card payment option is selected from the retailer web-page and the scratch-off/peel-away concealed PIN code 204 is entered by the user or provided by the NFC device transaction manager application 325 to confirm and complete the transaction.

Returning to block 412, if the user does not elect to conduct a purchasing transaction/redemption by using NFC card 102, then process 400 progresses to block 418 where it is determined whether the user elects to add value to NFC card 102. If so, in block 420, the user enters information from the account, such as, for example, a credit card, bank account, or another gift card, to pay for and furnish the value to be added to the NFC card 102 account. As noted above, there may be no need to require the user to prove knowledge of the secret PIN code for such a transaction, so such proof may be optional and dependent on retailer policies.

If the user does not elect to add value to NFC card 102, then process 400 determines whether to save the NFC-related information for future reference, in block 422. If so, in block 424, the NFC manager application 325 uses secure memory 314 or the TPM 315 to store information such as the NFC card 102 number, URL access data, secret PIN code, and possibly the user's personal information such as name and address. With this information saved and protected from malware, the NFC manager application 325 can display and use this information in the future without requiring the user to physically present NFC card 102 again.

Process 400 then progresses to block 426 where the transaction as well as the communication link is terminated.

By virtue of the disclosed configurations and processes, a NFC contactless online transaction is achieved that is secure, convenient, and expedient. That is, the disclosed embodiments avoid the manual entry of web addresses and card numbers to effect an online transaction.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary aspects of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of method, processing elements, or sequences, or the use of numbers, letters, or other designations therefore, is not intended to limit the claimed processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. An electronic device, comprising:
a display unit;
a secure memory unit;
a near field communication (NFC) reading mechanism configured to contactlessly read NFC-compliant provisioning information including a monetary value; and
logic configured to:
initiate establishment of a communication link,
automatically send a request message to confirm the read provisioning information via the communication link,
store at least a portion of the provisioning information in the secure memory unit, and
based on the confirmation of the provisioning information, automatically present on the display unit, the monetary value, selectable transaction options, and an online information resource link to accommodate execution of a selected transaction option.

2. The electronic device of claim 1, further comprising an input device configured to enter a selection of a transaction option and a PIN code.

3. The electronic device of claim 1, wherein the NFC-compliant provisioning information comprises one or more of the following: concealed NFC ID data, retailer data, retailer URL access data associated with the online information resource interface, monetary value data, account data, security data, secret data, user personal information, user contact information.

4. The electronic device of claim 3, wherein the NFC-compliant provisioning information is stored in a card, a wristband, sticker, banner, or key fob.

5. The electronic device of claim 1, wherein the secure memory unit comprises a trusted platform module (TPM).

6. The electronic device of claim 1, further comprising a microprocessor, memory controller, and memory integrated on a system-on-chip (SoC) module.

7. The electronic device of claim 1, wherein the selectable transaction options comprise one or more of the following: conducting a purchase transaction, conducting a redemption transaction, adding monetary value to account, saving NFC information for future transactions, application of coupons or vouchers.

8. The electronic device of claim 7 wherein, upon selection of the purchase transaction or redemption transaction, the online information resource link is activated to launch a retailer online interface, corresponding to the retailer data of the provisioning information, to accommodate execution of the purchase or redemption transaction.

9. The electronic device of claim 7 wherein, upon selection of the adding monetary value to account transaction, the online information resource link is activated to launch a retailer online interface, corresponding to the retailer data of the provisioning information, to accommodate execution of the adding monetary value transaction.

10. The electronic device of claim 7 wherein, upon selection of the saving NFC information for future transactions, one or more of the concealed NFC ID data, retailer data, retailer URL access data associated with the online information resource interface, monetary value data, account data, security data, secret data, user personal information, user contact information is stored in secure memory to automate subsequent transactions.

11. A system comprising:
a near field communication (NFC) device, including:
a transceiver and antenna, and
a memory device configured to store NFC-compliant provisioning information including a monetary value; and
an electronic device, including:
a display unit;
a secure memory unit;
an NFC reading mechanism configured to contactlessly read NFC-compliant provisioning information including a monetary value from the NFC device; and
logic configured to:
initiate establishment of a communication link,
automatically send a request message to confirm the read provisioning information via the communication link,
store at least a portion of the provisioning information in the secure memory unit, and
based on the confirmation of the provisioning information, automatically present on the display unit, the monetary value, selectable transaction options, and an online information resource interface link to accommodate execution of a selected transaction option.

12. The system of claim 10, further comprising an input device configured to enter a selection of a transaction option and a PIN code.

13. The system of claim 10, wherein the NFC-compliant provisioning information comprises one or more of the following: concealed NFC ID data, retailer data, retailer URL access data associated with the online information resource interface, monetary value data, account data, security data, secret data, user personal information, user contact information.

14. The system of claim 10, wherein the NFC device comprises one of the following: a card, wristband, sticker, banner, or key fob.

15. The system of claim 10, wherein the secure memory unit comprises a trusted platform module (TPM).

16. The system of claim 10, further comprising a microprocessor, memory controller, and memory integrated on a system-on-chip (SoC) module.

17. The system of claim 10, wherein the selectable transaction options comprise one or more of the following: conducting a purchase transaction, conducting a redemption transaction, adding monetary value to account, saving NFC information for future transactions, application of coupons or vouchers.

18. The system of claim 10 wherein, upon selection of the purchase transaction or redemption transaction, the online information resource link is activated to launch a retailer online interface, corresponding to the retailer data of the provisioning information, to accommodate execution of the purchase or redemption transaction.

19. The system of claim 10 wherein, upon selection of the adding monetary value to account transaction, the online information resource link is activated to launch a retailer online interface, corresponding to the retailer data of the provisioning information, to accommodate execution of the adding monetary value transaction.

20. The system of claim 10 wherein, upon selection of the saving NFC information for future transactions, one or more of the concealed NFC ID data, retailer data, retailer URL access data associated with the online information resource interface, monetary value data, account data, security data, secret data, user personal information, user contact information is stored in secure memory to automate subsequent transactions.

21. A method comprising:
contactlessly reading near field communication (NFC)-compliant provisioning information that includes a monetary value;
initiating establishment of a communication link;
automatically sending a request message to confirm the read provisioning information via the communication link;
storing at least a portion of the provisioning information in a secure memory unit;
automatically presenting, on a display unit, the monetary value, selectable transaction options, and an online information resource interface link to accommodate execution of a selected transaction option, in response to the confirmation of the provisioning information.

22. The method of claim 21, wherein the NFC-compliant provisioning information comprises one or more of the following: concealed NFC ID data, retailer data, retailer URL access data associated with the online information resource interface, monetary value data, account data, security data, secret data, user personal information, user contact information.

23. The method of claim 21, wherein the selectable transaction options comprise one or more of the following: conducting a purchase transaction, conducting a redemption transaction, adding monetary value to account, saving NFC information for future transactions, application of coupons or vouchers.

24. The method of claim 23, further comprising inputting a selection of a transaction option and a PIN code via an input device.

25. The method of claim 21 wherein, upon selecting the purchase transaction or redemption transaction, activating the online information resource link to launch a retailer online interface, corresponding to the retailer data of the provisioning information, to accommodate execution of the purchase or redemption transaction.

26. The method of claim 21 wherein, upon selecting the adding monetary value to account transaction, activating the online information resource link to launch a retailer online interface, corresponding to the retailer data of the provisioning information, to accommodate execution of the adding monetary value transaction.

27. The method of claim 21 wherein, upon selecting the saving NFC information for future transactions, storing in secure memory one or more of the concealed NFC ID data, retailer data, retailer URL access data associated with the online information resource interface, monetary value data, account data, security data, secret data, user personal information, to automate subsequent transactions.
